(19) United States
(12) Patent Application Publication
(10) Pub. No.: US 2007/0005462 A1
(43) Pub. Date: Jan. 4, 2007

(54) MEDICAL PROCEDURE COSTING SYSTEM AND METHOD

(75) Inventor: Annette Dopp, Glencoe, IL (US)

Correspondence Address: SNELL & WILMER, 400 EAST VAN BUREN, ONE ARIZONA CENTER, PHOENIX, AZ, 85004-2202, US

(73) Assignee: AORN MANAGEMENT SOLUTIONS, INC., Denver, CO (US)

(21) Appl. No.: 11/160,014

(22) Filed: Jun. 6, 2005

(51) Int. Cl. G06Q 50/00

(52) U.S. Cl. 705/34

(57) ABSTRACT

A system and method for analyzing utilization against costs for a surgical procedure is disclosed. The invention analyzes the cost of doing business by the amount of time a procedure occupies space in the operating room. Hospitals may utilize the invention and its results to identify profitable growth, pursue appropriate service lines, optimize the surgeon recruitment process, standardize supply usage, negotiate improved reimbursement contracts, properly identify a payer mix, and benchmark their performance with other institutions.

### FIELD OF INVENTION

The invention generally relates to determining an average cost for a medical procedure, and more particularly, to a system and method for determining the average cost per surgical procedure for a particular surgeon based, in part, upon an amount of time the procedure occupies an operating room.

### BACKGROUND OF INVENTION

Healthcare costs have been skyrocketing in recent years, while margins have been shrinking. For example, implant pricing continues to rise (e.g., almost 90% from 1991-2002) with one implant procedure experiencing four price increases in a single year, medical salaries have been increasing dramatically, and general medical inflation is increasing, yet insurance reimbursements have been flat and not keeping pace with medical inflation. With the largest percentage of the population reaching their most critical years for healthcare services, most healthcare institutions have been trying to find ways to manage and reduce costs. However, the accounting, financial and costing models used in the healthcare industry are complicated, so very few decision-makers know how costs are allocated. Moreover, when certain hospitals try to manage their healthcare costs, they typically incorporate many assumptions, react to misleading costing data from outside sources, and utilize basic averaging techniques, thereby leading to inaccurate or ineffective information, inefficient operations and costly decisions. Furthermore, costing out procedures is a difficult and time-consuming process, and many hospitals do not have sufficient resources (e.g., funds or staff), so the hospitals often lack the infrastructure to track costs.

Many studies have revealed that substantial cost savings may be found in the operating room. However, without an acceptable understanding of the costs involved in a surgical procedure, a medical program may be damaged. In the past, hospitals attempted to understand costs by analyzing the actual costs, the number of procedures, average costs for similar care of certain populations of patients, assumptions, and reimbursement data. However, a long-felt need exists for a consistent costing model that allows for longitudinal study, along with a system and method for determining a more accurate average cost associated with a surgical procedure based upon the length of the procedure.

### SUMMARY OF INVENTION

The present invention overcomes the shortcomings of the prior art by providing a consistent costing model that allows for longitudinal study. In one embodiment, the invention includes a system and method for determining the average cost per surgical procedure based upon the length of the procedure for a particular surgeon over a time period. Hospitals may utilize the invention and its results to identify profitable growth, pursue appropriate service lines, optimize the surgeon recruitment process, standardize supply usage, negotiate improved reimbursement contracts, properly identify a payer mix, and benchmark their performance with other institutions.

More particularly, the invention includes a method for facilitating a costing of a procedure at a facility for a time period. The invention includes a costing engine which facilitates acquiring a surgeon name; receiving a selected procedure; acquiring a total number of the selected procedure during the time period; acquiring costing data for the selected procedure during the time period, wherein the costing data is based upon an amount of time the selected procedure occupies an operating room; and, calculating total costs for the selected procedure during the time period. The costing data may include one or more of average room utilization, average staffing cost, average supply cost, estimated overhead cost, estimated ambulatory surgery unit (ASU) cost, estimated post anesthesia care unit (PACU) cost, average cost per facility stay and estimated anesthesia cost.

### BRIEF DESCRIPTION OF THE DRAWINGS

A more complete understanding of the present invention may be derived by referring to the detailed description and claims when considered in connection with the Figures. In the Figures, like numerals refer to similar elements throughout.

FIG. 1 is an exemplary system diagram in accordance with the present invention;

FIG. 2 is an flowchart showing an exemplary case costing method for implementing the present invention; and,

FIG. 3 shows exemplary results of a case costing model in accordance with the present invention.

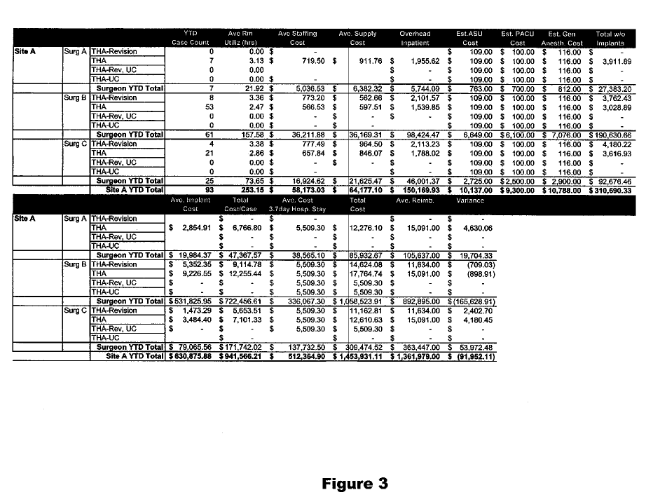

### DETAILED DESCRIPTION

The detailed description of exemplary embodiments herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

As will be appreciated by one of ordinary skill in the art, the system may be embodied as a customization of an existing system, an add-on product, upgraded software, a stand alone system, a distributed system, a method, a data processing system, a device for data processing, and/or a computer program product. Accordingly, the system may take the form of an entirely software embodiment, an entirely hardware embodiment, or an embodiment combining aspects of both software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The invention includes a system 1 and method 200 for determining the average cost per surgical procedure for a particular surgeon. In one embodiment, the invention includes an improved method 200 for analyzing utilization against costs by analyzing the cost of doing business by the amount of time a procedure occupies space in the operating room. Facilities (e.g., hospitals) may utilize the invention and its results to identify profitable growth, pursue appropriate service lines, optimize the surgeon recruitment process, standardize supply usage, negotiate improved reimbursement contracts, properly identify a payer mix, and benchmark their performance with other institutions. More specifically, the invention may facilitate identifying profitable growth and enabling a facility to make better decisions on service lines offered. For example, with regard to a bariatric program (i.e., stomach stapling), if the program did not generate sufficient revenue or profit, the facility may determine that it may not be worth pursuing due to the high costs of obtaining special instrumentation, large operating room tables, large transport carts, large hospital beds, and the like. Moreover, staffing costs may increase due to the potential increase in staff injuries attempting to help the larger patients or utilizing the larger equipment. The invention facilitates the optimization of the recruitment process by, for example, providing an analysis of surgeon cost per case of incoming surgeons against existing surgeons (or against surgeons on national level) such that the facility (e.g., division chiefs) may develop an informed recruitment decision. The facility may also discuss expectations to control costs and develop a strategy prior to hiring the surgeon. The invention also facilitates the analysis of payer mix by service line and the sharing of aggregate data to allow benchmarking among institutions.

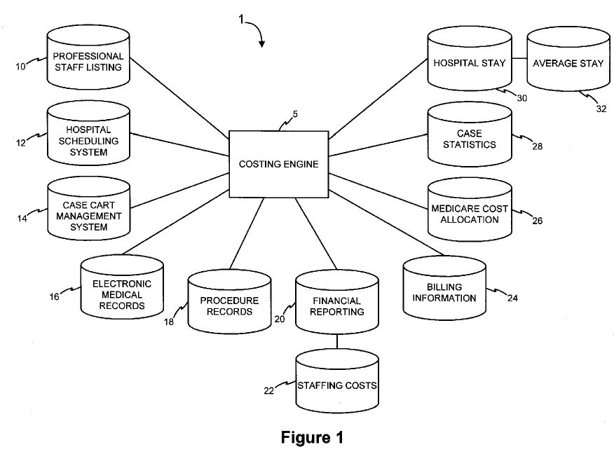

With respect to FIG. 1, system 1 includes a costing engine 5 which interfaces with multiple databases. The interfaces may include any known in the art or discussed herein networks, protocols or communication devices. Costing engine 5 is suitably configured to acquire data, submit queries, perform calculations, develop charts and graphs, create reports using any of the data discussed herein or acquired from outside sources, and/or the like. The databases include, for example, professional staff listing database 10, hospital scheduling system database 12, case card management system database 14, electronic medical records database 16, procedure records database 18, financial reporting database 20 (includes staffing costs from staffing costs database 22), billing information database 24, Medicare cost allocation database 26, case statistics database 28 and hospital stay database 30 (includes average stay information from average stay database 32).

Costing engine 5 or any of the other system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: patient data; facility data; procedure data, hospital system data; and/or like data useful in the operation of the system. As those skilled in the art will appreciate, user computer may include an operating system (e.g., Windows NT, 95/98/2000, OS2, UNIX, Linux, Solaris, MacOS, etc.) as well as various conventional support software and drivers typically associated with computers. The computer may include any suitable personal computer, network computer, workstation, minicomputer, mainframe or the like. User computer can be in a home or business environment with access to a network. In an exemplary embodiment, access is through a network or the Internet through a commercially-available web-browser software package.

As used herein, the term “network” shall include any electronic communications means which incorporates both hardware and software components of such. Communication among the parties may be accomplished through any suitable communication channels, such as, for example, a telephone network, an extranet, an intranet, Internet, point of interaction device (point of sale device, personal digital assistant (e.g., Palm Pilot®), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. Moreover, although the system is frequently described herein as being implemented with TCP/IP communications protocols, the system may also be implemented using IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, Dilip Naik, Internet Standards and Protocols (1998); Java 2 Complete, various authors, (Sybex 1999); Deborah Ray and Eric Ray, Mastering HTML 4.0 (1997); and Loshin, TCP/IP Clearly Explained (1997) and David Gourley and Brian Totty, HTTP, The Definitive Guide (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., Gilbert Held, Understanding Data Communications (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

As used herein, “transmit” may include sending electronic data from one system component to another over a network connection. Additionally, as used herein, “data” may include encompassing information such as commands, queries, files, data for storage, and the like in digital or any other form.

The system contemplates uses in association with web services, utility computing, pervasive and individualized computing, security and identity solutions, autonomic computing, commodity computing, mobility and wireless solutions, open source, biometrics, grid computing and/or mesh computing.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based and Packet Filtering among others. Firewall may be integrated within an web server or any other components or may further reside as a separate entity.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789.456). The web server retrieves the appropriate web pages and sends the data or applications for the web pages to the IP address. Web services are applications that are capable of interacting with other applications over a communications means, such as the internet. Web services are typically based on standards or protocols such as XML, SOAP, WSDL and UDDI. Web services methods are well known in the art, and are covered in many standard texts. See, e.g., Alex Nghiem, IT Web Services: A Roadmap for the Enterprise (2003), hereby incorporated by reference.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

Any databases discussed herein may include relational, hierarchical, graphical, or object-oriented structure and/or any other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, surgeons, physicians, administrators, nurses, staff, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

A facility includes any site, location, building, software and/or hardware such as, for example, a healthcare facility, hospital and/or hospital system. A hospital system may include multiple facilities (e.g., clinics, satellite offices) or hospitals. The invention may be discussed herein with respect to hospitals, but it may apply to any facility.

A surgeon includes any person, entity, software and/or hardware such as, for example, an individual physician, a healthcare worker, all surgeons of the same specialty (e.g., General Surgery, Orthopedics, Plastics, Urology, etc), all surgeons at a particular facility, or any other combination or subset of surgeons. In one embodiment, after a surgeon name is entered into the system, the name may be coded, masked, encrypted or reconfigured in any way to conceal the actual name. The invention may be discussed herein with respect to surgeons and surgeon names, but it may apply to any healthcare worker or any other person in any industry.

A procedure includes any processes, routines, cases, steps, surgeries, medical act or any other action. Exemplary surgical procedures include: Total Hip Arthroplasty (THA), Total Knee Arthroplasty (TKA), Coronary Artery Bypass Grafting (CABG), Laparoscopic Cholecystectomies (Lap Chole), and Cataract Surgery (Phaco/IOL). The total number of procedures includes the number of procedures which are performed in a particular time period such as, for example, one year. In one embodiment, the total number of procedures may include an annualized number of procedures.

The average room utilization includes the total minutes that a patient is in the operating room for a time period. The room utilization is calculated by, for example, using patient in room time (PIR) to patient out of room time (POR). To obtain a more accurate time average, the system (e.g., via manual selection or automatic deletion for cases outside of a certain time range) may eliminate a subset or all outlier cases such as, for example, cases which include unexpected bleeding, patient arrests, difficult anatomy and the like. In one embodiment (and which may apply to any of the calculations discussed herein), the system converts time fields to a common unit of measurement (e.g., minutes), to facilitate subtracting PIR from POR, then dividing by 60 to obtain the room utilization in hours. In an exemplary embodiment, the total time in the operating room may be much longer than the total minutes of surgery (i.e., “cut to close”). The total time in the operating room may exceed two hours beyond the surgery time for complex cases such as, for example, cervical fusion, brain surgery, hip arthroplasties and open heart surgery. The excess time may include, for example, transferring the patient to the surgery table, the anesthesia process, positioning the patient, preparation of the patient, the surgery time, waking the patient and moving the patient to the cart.

The average staffing cost includes, for example, the total salaries for a time period for a certain number of staff (e.g., all staff involved in the surgery) as reported on financial reports (including benefits) divided by the total hours of surgery for that time period multiplied by 60 (to convert to minutes). An exemplary average staffing cost is about $4-$6/minute. While most institutions compare employee expenses against the number of procedures, the present system takes into account the length of procedure. In other words, the present system includes an improved method for analyzing utilization against costs by analyzing the cost of doing business by the amount of time a procedure occupies space in the operating room.

The average supply cost includes, for example, the average supply cost for a specific procedure divided by the number of procedures performed by a particular surgeon during a time period. In one embodiment, for procedures with expensive implants above a predetermined threshold, the implants are separated out from the rest of the supplies and analyzed separately.

The estimated overhead cost per procedure includes, for example, department total overhead cost for a time period divided by the total minutes of surgery for a time period, then multiplied by the average room utilization number for a time period. If a facility does not have access to Medicare costs, the system may include a rough estimate of overhead costs by using 60% of supply costs for outpatients and 90% of supply costs for inpatients, for a time period.

The estimated Ambulatory Surgery Unit (ASU) cost includes, for example, the average cost per patient visit to the ASU. The ASU sometimes referred to as the Same Day Surgery Unit (SDS). The ASU average cost is calculated by, for example, dividing the total ASU operating expense for a time period by the number of patient visits during that same time period. In another embodiment, individual costs per patient may be incorporated; however, individual costs typically do not vary significantly from patient to patient.

The estimated Post Anesthesia Care Unit (PACU) costs include, for example, the average cost per patient visit to the PACU. The average PACU cost is calculated by, for example, dividing the total PACU operating expense for a time period by the number of patient visits that same time period. The PACU is also known as the Recovery Room. In another embodiment, individual costs per patient may be incorporated; however, individual costs typically do not vary significantly from patient to patient.

The estimated anesthesia costs include, for example, average cost per procedure for a time period. In one embodiment, the costs are analyzed by categories such as, for example, General Anesthesia, Spinal/Regional Anesthesia, and Monitored Anesthesia Care (MAC) (otherwise known as Intravenous (IV) conscious sedation). Most procedures include a consistent or preferred anesthesia type for the procedure (e.g., all Lap Chole's are General Anesthesia).

The total cost per procedure includes the sum of all costs per procedure including, for example, average room utilization, average staffing cost, average supply cost, estimated overhead cost, estimated ASU cost, estimated PACU cost, average cost per facility stay and estimated anesthesia cost.

The average cost per facility (e.g., hospital) stay includes, for example, the average cost of one Inpatient (IP) day multiplied by the average length of stay (LOS) for a particular surgeon's patient population for a time period. The IP cost per day typically varies by facility and LOS typically varies from surgeon to surgeon. High or long length of stays will significantly decrease profitability margin for a procedure, so facilities typically monitor the length of stay closely.

The average reimbursement includes the average of all reimbursements for a time period. The variance includes, for example, the difference between the average reimbursement and the total costs per procedure.

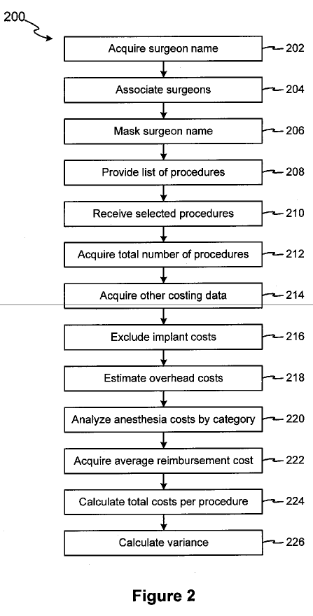

Referring now to FIG. 2, the process flow depicted is merely an embodiment and is not intended to limit the scope of the invention as described herein. For example, the steps recited in the method descriptions may be executed in any order and are not limited to the order presented. It will be appreciated that the following description makes appropriate references not only to the steps depicted in FIG. 2, but also to the various system components as described above with reference to FIG. 1.

The system and method may be described herein in terms of functional block components, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, Macromedia Cold Fusion, Microsoft Active Server Pages, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

The system and method is described herein with reference to block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

With respect to method 200 in FIG. 2, costing engine 5 may receive information via any communication device or protocol known in the art or discussed herein. For example, costing engine 5 may receive information via a web form (with drop down menus, entry fields, selections, etc), email, facsimile, voice response system, data entry, and the like. Costing engine 5 may also periodically run certain queries to obtain any data discussed herein within a predetermined time period. Costing engine 5 may initially receive facility and surgeon information. Costing engine 5 acquires a surgeon name (step 202) from the professional staff listing database 10. Costing engine 5 may also acquire other surgeon names and associate the surgeons (step 204) based on certain categories or groupings such as, for example, all surgeons at a particular facility or all surgeons of the same specialty. In one embodiment, costing engine 5 masks the surgeon names (step 206) and assigns a different letter to each surgeon (e.g., surgeon A, surgeon B, etc.).

In one embodiment, costing engine 5 provides a list of procedures (step 208) for a facility to select from (e.g., drop down list) such that participating facilities may benchmark their results against other facilities. The facility identifies its procedures that are similar to, or match, the list acquired from costing engine 5 and transmits its selected facilities to costing engine 5. In another embodiment, costing engine 5 may provide a field for entry of any procedure (or entry of any code or transmission of any signal related to a procedure). Upon receiving selected procedures (step 210), costing engine 5 acquires the total number of procedures (step 212) related to the selected procedures from hospital scheduling system database 12 and/or case card management system database 14 associated with a particular hospital. Costing engine 5 may also run certain queries to obtain procedure data within any predetermined time period.

Costing engine 5 acquires additional costing data (step 214) from one or more of the exemplary databases set forth in FIG. 1 or any other internal or external database which may include relevant information. For example, costing engine 5 acquires average room utilization and any other data related to room utilization from electronic medical record database. Costing engine 5 acquires staffing cost and any other data related to the staffing cost from financial reporting database 20 and/or procedure records database 18, including information related to the hours of surgery.

Costing engine 5 acquires supply costs and any other data related to the supply costs from case card management system database 14, procedure record database and/or billing information database 24. In one embodiment, for procedures with expensive implants above a predetermined threshold, costing engine 5 analyzes the rest of the supplies, but does not include the cost of the implants (step 216), which are analyzed separately.

Costing engine 5 also acquires overhead costs and any other data related to the overhead costs from Medicare cost allocation database 26 and/or procedure record database. In one embodiment, if a facility does not have access to Medicare costs, costing engine 5 may include a rough estimate of overhead costs. Costing engine 5 may estimate the overhead costs by using a percentage of actual costs (step 218). For example, costing engine 5 may estimate the overhead costs by using 60% of supply costs for outpatients and 90% of supply costs for inpatients.

Costing engine 5 acquires the anesthesia costs and any other data related to the anesthesia costs from financial reporting database 20 and/or case statistic database. In one embodiment, costing engine 5 acquires or analyzes anesthesia costs by categories (step 220) such as, for example, General Anesthesia, Spinal/Regional Anesthesia, and Monitored Anesthesia Care (MAC) (otherwise known as Intravenous (IV) conscious sedation). Most procedures include a consistent or preferred anesthesia type for the procedure (e.g., all Lap Chole's are General Anesthesia). As such, in an exemplary embodiment, estimated anesthesia costs include the total cost per anesthesia type.

Costing engine 5 acquires ASU costs, PACU costs and reimbursement costs (and any other data related to the these costs) from financial reporting database 20. The average reimbursement includes, for example, the average of all reimbursements (step 222). Costing engine 5 also acquires the hospital stay costs and any other data related to the hospital stay from hospital stay database 30, which may obtain average stay information from average stay database 32. Any calculations associated with the data acquired by costing engine 5 may be performed within the original database, by another component or processor, or by costing engine 5 itself.

After acquiring the appropriate data, costing engine 5 then calculates the total cost per procedure (step 224). In one embodiment, the total cost per procedure includes the sum of the certain individual costs per procedure for a time period. The costs per procedure include, for example, average room utilization, average staffing cost, average supply cost, estimated overhead cost, estimated ASU cost, estimated PACU cost, average cost per facility stay and estimated anesthesia cost. Costing engine 5 may also calculate a variance (step 226). A variance includes, for example, the difference between the average reimbursement and the total costs per procedure.

As one skilled in the art will appreciate, while the invention is described with respect to medical procedures, the system and methods of the invention may be applicable to costing any type of procedure, routine, asset, hardware, software and the like. Any database, software, hardware and/or component discussed herein may include printed documents, data stored in memory on a computer, data stored on a portable medium (CD, diskette, etc) or any other system or method for storing, acquiring and manipulating data. Any database searching or queries may be accomplished by hardware, software, viewing a database, or manual searching. While the invention is described with respect to acquiring information from particular databases, one skilled in the art will appreciate that any information or subset of information may be included in one database, a local database, a remote database, multiple databases or any of the databases discussed herein. Moreover, any person, facility, item, component, software or hardware discussed herein in a singular form may also include more than one or a plurality.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. The scope of the invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described exemplary embodiments that are known to those of ordinary skill in the art are expressly incorporated herein by reference and are intended to be encompassed by the present claims.

What is claimed is:

1. A method for facilitating a costing of a procedure at a facility for a time period, said method including:
acquiring a surgeon name;
receiving a selected procedure;
acquiring a total number of said selected procedure during said time period;
acquiring costing data for said selected procedure during said time period, wherein said costing data is based upon an amount of time said selected procedure occupies an operating room; and,
calculating total costs for said selected procedure during said time period.

2. The method of claim 1, wherein said step of acquiring a total number of said selected procedure includes an annualized number of said selected procedure.

3. The method of claim 1, wherein said step of acquiring costing data includes acquiring average room utilization by calculating the total minutes a patient is in an operating room for said selected procedure.

4. The method of claim 1, wherein said step of acquiring costing data includes acquiring average room utilization by calculating a total minutes a patient is in an operating room for said selected procedure by subtracting patient in room time (PIR) from patient out of room time (POR) and eliminating outlier cases.

5. The method of claim 1, wherein said step of acquiring costing data includes acquiring average staffing costs by calculating total salaries for said time period for certain staff, then dividing by a total surgery time for said time period.

6. The method of claim 1, wherein said step of acquiring costing data includes acquiring average supply cost by dividing an average supply cost for said selected procedure for said time period by a number of said selected procedure performed by said surgeon name for said time period.

7. The method of claim 1, wherein said step of acquiring costing data includes excluding costs associated with implant parts.

8. The method of claim 1, wherein said step of acquiring costing data includes excluding costs associated with implant parts costing above a predetermined threshold.

9. The method of claim 1, wherein said step of acquiring costing data includes acquiring estimated overhead costs for said selected procedure by dividing an overhead cost associated with a department of said facility by a total surgery time for said time period, then multiplying by said average room utilization for said time period.

10. The method of claim 1, further including estimating overhead costs based upon a percentage of actual costs.

11. The method of claim 1, wherein said step of acquiring costing data includes acquiring ambulatory surgery unit (ASU) costs by dividing ASU operating expenses for said time period by number of patient visits during said time period.

12. The method of claim 1, wherein said step of acquiring costing data includes acquiring ASU costs by acquiring individual costs per patient during said time period.

13. The method of claim 1, wherein said step of acquiring costing data includes acquiring post anesthesia care unit (PACU) costs by dividing ASU operating expenses for said time period by number of patient visits during said time period.

14. The method of claim 1, wherein said step of acquiring costing data includes acquiring PACU costs by acquiring individual costs per patient during said time period.

15. The method of claim 1, wherein said step of acquiring costing data includes acquiring anesthesia costs by anesthesia category.

16. The method of claim 1, further including calculating an average cost for each stay at said facility.

17. The method of claim 1, further including calculating an average cost for each stay at said facility by multiplying an average cost of one inpatient day by an average length of stay for a patients associated with said surgeon name.

18. The method of claim 1, further including calculating a variance by deducting said total costs per procedure for said time period from an average reimbursement cost for said time period.

19. The method of claim 1, further including grouping a plurality of surgeon names into categories.

20. The method of claim 1, further including grouping a plurality of surgeon names into categories, wherein said categories include at least one of all surgeons at a facility during said time period and all surgeons associated with a specialty during said time period.

21. The method of claim 1, further including masking said surgeon name.

22. The method of claim 1, wherein said step of receiving a selected procedure includes providing a list of procedures for selection by said facility.

23. The method of claim 1, wherein said step of acquiring costing data includes acquiring at least one of average room utilization, average staffing cost, average supply cost, estimated overhead cost, estimated ambulatory surgery unit (ASU) cost, estimated post anesthesia care unit (PACU) cost, average cost per facility stay and estimated anesthesia cost.

24. A machine-readable medium having stored thereon a plurality of instructions, said plurality of instructions when executed by a processor, cause said processor to perform a method comprising the steps of:
acquiring a surgeon name;
receiving a selected procedure;
acquiring a total number of said selected procedure during said time period;
acquiring costing data for said selected procedure during said time period, wherein said costing data is based upon an amount of time said selected procedure occupies an operating room; and,
calculating total costs for said selected procedure during said time period.
